(19) United States
(12) Patent Application Publication
(10) Pub. No.: US 2016/0241533 A1
(43) Pub. Date: Aug. 18, 2016

(54) System and Method for Granular Tagging and Searching Multimedia Content Based on User's Reaction

(71) Applicants: Anurag Bist, Newport Beach, CA (US); Hamid Lalani, Dove Canyon, CA (US)

(72) Inventors: Anurag Bist, Newport Beach, CA (US); Hamid Lalani, Dove Canyon, CA (US)

(21) Appl. No.: 14/942,182

(22) Filed: Nov. 16, 2015

Related U.S. Application Data
(63) Continuation-in-part of application No. 13/291,064, filed on Nov. 7, 2011, now Pat. No. 9,202,251.

(51) Int. Cl. H04L 29/06; H04N 21/8549; H04N 21/845; G06F 17/30; H04N 21/442

(52) U.S. Cl. CPC H04L 63/08; G06F 17/30035; H04N 21/44218; H04N 21/8456; H04N 21/8455; H04N 21/8549

(57) ABSTRACT

A system and a method for tagging content based on individual cues, emotional score or emotional profile is provided, where the content is a video file, a webpage, a mobile application, a product review or product demo video is provided. The method involves authorizing a user to access the content; capturing a user specific data, an application details and a content specific data in response to the content in real-time; analyzing the captured user specific data, the application detail and the content specific data to generate a user emotional profile; and tagging the user emotional profile with the content in a time granular manner.

### CROSS-REFERENCE TO RELATED APPLICATION

This application is a continuation-in-part of U.S. patent application Ser. No. 13/291,064 filed Nov. 7, 2011, now pending; the disclosures of which are hereby incorporated by reference in their entirety.

### FIELD OF THE INVENTION

The present invention relates generally to a method for granular tagging of multimedia content in a connected network, and more particularly, to a system that has an ability to add meaningful contextual and personalized information to the content in a granular fashion.

### BACKGROUND OF THE INVENTION

With the growth of connected infrastructure, social networking has become more ubiquitous in everyday lives. A large part of our lives is being dictated by online or otherwise accessible content, and how this content is influenced by the tools and the network that connect us. Recent examples include the changes in platforms like Facebook where they are using services like Spotify to deliver content to match people's preferences, partnership of Netflix with Facebook to make their content repository more ‘social’, Hulu's existing social media tools, and other similar services.

While the above attempts are steps towards making content more relevant for classification, these still don't address a few fundamental issues: (a) how to pin-point specific areas in a content (video or audio) file that could highlight the usefulness of the content in a particular context, (b) some indication of the “True” reactions of individuals, groups of individuals, or a large demography of people to a particular content, or a specific area of the content, (c) a method, or platform to make such granular tagging, rating, and search of content happen in a generic and scalable way.

In light of above, a method and a system for a scalable platform is provided that enables granular tagging of any multimedia or other web content over connected networks. The method of the invention provides an ability to go in much more granular within a content and enable a way to add meaningful contextual and personalized information to it, that could then be used for searching, classifying, or analyzing the particular content in a variety of ways, and in a variety of applications.

### OBJECTS OF THE INVENTION

It is a primary object of the invention to provide a system for tagging the content based on the individual and personal cues of the users. One example of these cues is emotional profile or emotional score of the users.

It is a further object of the invention to provide a method for tagging a multimedia content in a granular manner.

It is still a further object of the invention to provide a system that provides a uniform way of continuous and granular tagging of the multimedia content via individual cues, emotional profiles, or emotional scores.

A further and related object of the invention is to provide a method of tagging the content with an instantaneous Emotional Score, an instantaneous Emotional Profile, or an individual cues score based on a specific user's reaction and at a specific time stamp of the content.

### BRIEF SUMMARY OF THE INVENTION

In one aspect of the present invention, a system for tagging a content is provided. The system comprising: an authorizing module configured to authorize a request coming from a user through a client device to access one or more content; a capturing means to capture a user specific data in response to said one or more content; an application module for accessing said one or more content, analyzing the captured user specific data and to generate a user emotional profile for a complete duration for which the user has interacted with the content; a processing means to tag the user emotional profile with the content in a time granular manner. The authorizing means further comprising a user opt-in providing one or more options for the user to access the system. The system further comprising a storing means to store said one or more content tagged with the user emotional profile. The storing means store a self reported user feedback, user emotional profile and user snapshot at timed interval along with the said one or more content tagged with the user emotional profile.

The user emotional profile is generated based on the user specific data, content specific data and application details. The user specific data comprises one or more of the data selected from captured snapshots, emotional variation of the user and a self reporting feedback. The application details comprise number of mouse clicks, number of clicked hyperlink or scroll tab. The content specific data comprises information on media event, session data elapsed event, time stamp and metadata.

In an embodiment, the content is a video file, a webpage, a mobile application, a product review or a product demo video. The application module for the video file functions by providing access to the video file; capturing the user specific data in real time; and analyzing the user specific data to generate the user emotional profile. The application module for the webpage perform the function of accessing the webpage, capturing the user specific data in real time and the content specific data; and analyzing the user specific data and the content specific data to generate the user emotional profile. The application module for the mobile application perform the function of accessing the mobile application, capturing the user specific data in real time and the application data; and analyzing the user specific data and the application data to generate the user emotional profile. The application module perform the function of accessing the product review, capturing the user specific data in real time and the content specific data and analyzing the user specific data and the content specific data to generate the user emotional profile.

In another aspect of the present invention, a method for tagging a content is provided. The method comprises: authorizing a request coming from a user through a client device to access one or more content; capturing a user specific data in response to said one or more content; using an application module to access said one or more content, to analyze the captured user specific data and to generate a user emotional profile for a complete duration for which the user has interacted with the content; and tagging the user emotional profile with the content in a time granular manner.

The method further comprising: storing said one or more content tagged with the user emotional profile in a storing means. The storing means store a self reported user feedback, user emotional profile and user snapshot at timed interval along with the said one or more content tagged with the user emotional profile.

The user emotional profile is generated based on the user specific data, content specific data and application details. The user specific data comprises one or more of the data selected from captured snapshots, emotional variation of the user and a self reporting feedback. The application details comprise number of mouse clicks, number of clicked hyperlink or scroll tab. The content specific data comprises information on media event, session data elapsed event, time stamp and metadata.

In an embodiment, the content may be a video file, a webpage, a mobile application, a product review or a product demo video. The application module for the video file function by providing access to the video file; capturing the user specific data in real time; and analyzing the user specific data to generate the user emotional profile. The application module for the webpage perform the function of accessing the webpage, capturing the user specific data in real time and the content specific data; and analyzing the user specific data and the content specific data to generate the user emotional profile. The application module for the mobile application perform the function of accessing the mobile application, capturing the user specific data in real time and the application data; and analyzing the user specific data and the application data to generate the user emotional profile. The application module perform the function of accessing the product review, capturing the user specific data in real time and the content specific data and analyzing the user specific data and the content specific data to generate the user emotional profile.

### BRIEF DESCRIPTION OF THE DRAWINGS

The invention will hereinafter be described in conjunction with the figures provided herein to further illustrate various non-limiting embodiments of the invention, wherein like designations denote like elements, and in which:

FIG. 1 illustrates a schematic representation of an embodiment of an interacting system for Emotional score or emotional profile based content tagging in connected network in accordance with an embodiment of the present invention.

FIG. 2 shows an exemplary illustration of granular tagging of multimedia content in accordance with an embodiment of the present invention.

FIG. 3 illustrates a flow diagram depicting the method for tagging the content in a granular manner in accordance with an embodiment of the present invention.

FIG. 4 illustrates a user interface showing the concept of granular emotion based tagging of multimedia content in accordance with an embodiment of the present invention.

FIG. 5 illustrates a system for tagging context or event, in accordance with an embodiment of the present invention.

FIG. 6 shows a block diagram illustrating the method for tagging context or event, in accordance with an embodiment of the present invention.

FIG. 7A shows a block diagram illustrating the method used by an application module for tagging a video file, in accordance with an exemplary embodiment of the present invention.

FIG. 7B shows a block diagram illustrating the method used by an application module for tagging a web page, in accordance with an exemplary embodiment of the present invention.

FIG. 7C shows a block diagram illustrating the method used by an application module for tagging a mobile application, in accordance with an exemplary embodiment of the present invention.

FIG. 7D shows a block diagram illustrating the method used by an application module for tagging a product review or a product demo video, in accordance with an exemplary embodiment of the present invention.

### DETAILED DESCRIPTION OF INVENTION

In the following detailed description of embodiments of the invention, numerous specific details are set forth in order to provide a thorough understanding of the embodiments of invention. However, it will be obvious to a person skilled in art that the embodiments of invention may be practiced with or without these specific details. In other instances well known methods, procedures and components have not been described in details so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

Nowadays with the increase in use of social networking and multimedia content repository, the content is rated based on the individuals liking and disliking of the content. Typically most rating and tagging of content are limited to the option whereby user manually enters the feedback either in form of “like” or “dislike”. The present invention provides a system and method that includes individual's cues, emotional scores or profiles to tag a multimedia content in a granular manner. The system combines individual cues score, emotional profile or emotional score of the user in a social networking set up to make a more powerful impact on the user's consumption habit. The present invention further extends the concept of individual cues score, Emotional Score or Emotional Profile tagging of content to a more granular level within a specific content and provides a method and a system to achieve this process in a uniform way, including ways to use such tagging for various methods of analytics and monetization models. The inclusion of individual cues scores, Emotional Scores or Emotional Profiles adds a very unique behavioral aspect to content that may then be used for searching, analytics and various kinds of monetization models for the particular content. The individual cue scores, Emotional Score or Profile is a combination of the emotion, behavior, response, attention span, gestures, hand and head movement, or other reactions or stimuli of the user collected through the sensors available in the client devices and then processed.

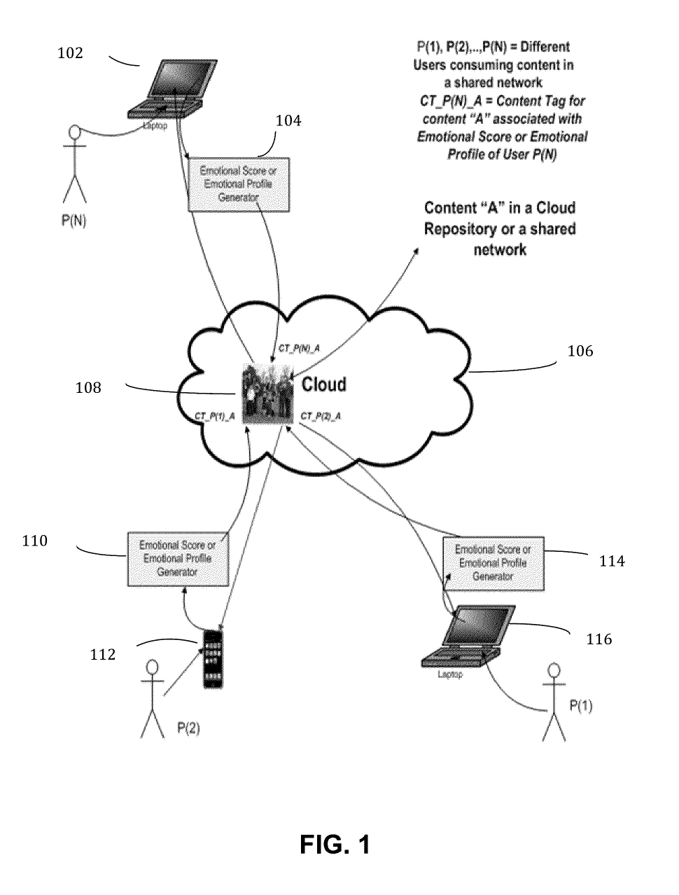

FIG. 1 illustrates a schematic representation of interacting system for individual cues score, Emotional Score or Emotional Profile based content tagging in connected network in accordance with an embodiment of the present invention. The system comprises of a plurality of (P(1), P(2), . . . , P(N)) connected to each other in a network through their respective client devices: client device 1 116, client device 2 112, and client device N 102. The client devices 102, 112 and 116 are configured with a server in the cloud network 106 that is having a multimedia repository containing content 108 that are accessible by the client devices of the users. The content A 108 is accessible by the different users in the network through their respective client devices 102, 112 and 116. The client devices 102, 112 and 116 have a module that has an inherent ability to continuously capture some critical auditory, visual, or sensory inputs from the individuals. This module is a functionality that may be a combination of the available sensors in the client device (camera/webcam, microphone, other sensors like tactile/haptic etc.) and the available processing modules present in the client devices. The client devices 102, 112 and 116 capture these inputs as they change in response to the individual's reaction to viewing of content A 108 that is part of connected media repository in cloud network 106. The individual cues score, emotional score or emotional profile generator 104 of client device N 102 generates the individual reaction, individual cues score, or emotional score of the user as a result of watching the content. The individual cues score, emotional score or the emotional profile of the user N associated with the content is then used to tag the content A 108 in form of CT_PN_A. Similarly the individual cues score, emotional score or reaction of the user 1 and user 2 is also generated by their respective individual cues score generator or emotional profile generator 114 and 110, and their scores are tagged to the content in form of CT_P1_A and CT_P2_A. As a result of this the content A 108 that has been watched by n number of users, and the individual reaction, individual cues score, or the emotional score (CT_P(1)_A), CT_P(2)_A, . . . , CT_P(3)_A) of each user as a result of watching the content is tagged to the content A 108. The individual cues score or the emotional score tagged to the content is then stored in the cloud network as an update on the individual cues profile or the Emotional Profiles of the users P(1), P(2), . . . P(N). Alternatively, the client devices need not generate and send individual reaction, individual cues score, or the emotional score to the cloud or server, and may instead transmit data (e.g. auditory, visual, or sensory inputs from the individuals) to one or more servers which process said data to create the individual cues score or the emotional score and update the individual cues profile.

In an embodiment of the present invention, the content A 108 tagged by the individual cues scores, Emotional Scores, or Emotional Profiles of a number of users may be used in multiple ways to increase the relevance of the content on an application specific, user specific, or delivery specific contexts.

In an embodiment of the present invention the client device 102 comprises of a single module or a plurality of modules to capture the input data from the individual, to process the input data for feature extraction and a decision phase for generating the profile of the user. Some examples of these input modules may be webcams, voice recorders, tactile sensors, haptic sensors, and any other kinds of sensory modules.

In another embodiment of the present invention, the client devices 102, 112 and 116 include but is not limited to being a mobile phone, a Smartphone, a laptop, a camera with WiFi connectivity, a desktop, tablets (iPAD or iPAD like devices), connected desktops or other sensory devices with connectivity.

In another embodiment of the present invention, the individual cues score, emotional profile or emotional score corresponds to the emotion, behavior, response, attention span, gestures, hand and head movement, or other reactions or stimuli of the user.

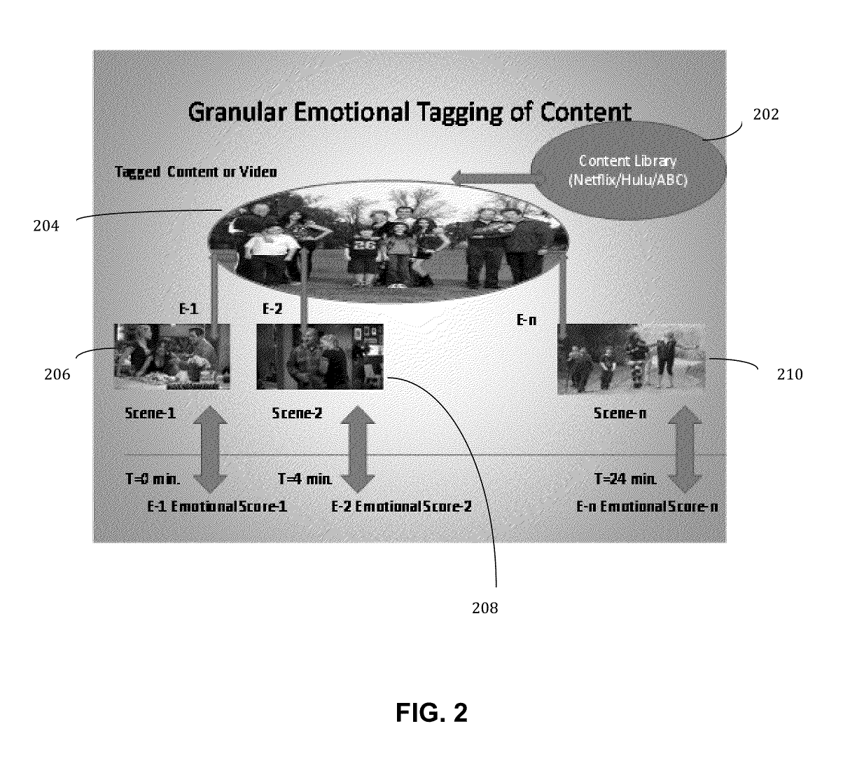

FIG. 2 shows an exemplary illustration of granular tagging of multimedia content in accordance with an embodiment of the present invention. The example illustrates a method that enables more granular tagging of a multimedia content by the different users. The example shows an episode of a TV show 204 that is 24 minute long that has to be tagged with the emotional score in a granular manner. The episode of TV show 204 is a part of content library 202 or connected repository. The users connected in the network have an access to the content library 202 through their respective client devices, and the content library 202 consists of various channels such as Netflix/Hulu/ABC that provides a link to various multimedia contents available online. When the user watches this multimedia content, the system tags the content by his reaction or emotional score at regular intervals. The example shows a TV show 204 that has to be tagged based on emotional score in a granular manner. While the TV show 204 is being watched by the user, the content is being tagged with the emotional score of the user watching the TV show 204 in a continuous manner. The TV show 204 is divided into number of time segments, for instance scene 1 206 is for time t=0. The emotional score of the user associated with scene 1 is E1. Similarly scene 2 208 is for time interval t=4 min and the emotional score associated with that particular time is E2. Thus, the tagging of the TV show 204 results in a number of tags that are associated with the exact time stamp of a particular segment. At the end of the tagging the TV show 204 now has several reactions or Emotional Score tags that are associated with specific time segments of the show.

In an embodiment of the present invention, the content 204 to be emotionally tagged is divided into a number of time segments, the segments being equally spaced. When the content 204 is tagged by the emotional score of a large number of users, the average emotional score for a particular time segment of the content 204 may be created. This in turn provides a unique way to classify different part of a TV show with very useful information about the user's reactions or Emotional Score tagged with respect to time segment of the TV show. In another embodiment of the present invention the tags may be individual cues of specific users that may include attention span, gestures, head and hand movements and other sensory inputs given by the users while watching a specific content.

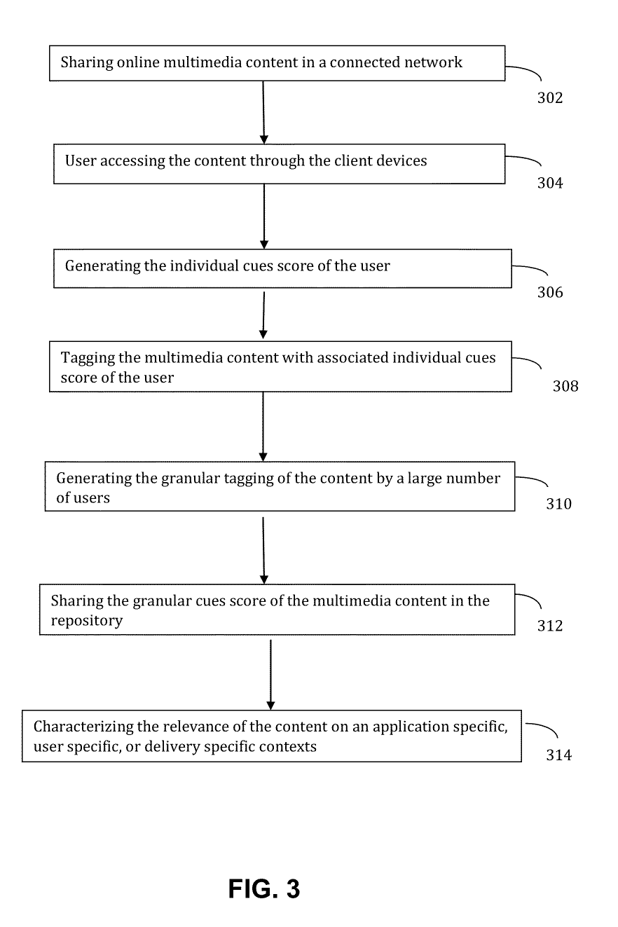

FIG. 3 illustrates a flow diagram depicting the method for tagging the content in a granular manner in accordance with an embodiment of the present invention. In an embodiment, the method include following steps: Step 302: The online media content is stored in multimedia repository which is connected to the server in the cloud network. The multimedia repository being configured to the server has an ability to share the content in the networked environment. Step 304: The plurality of users are connected in the network with each other and to the multimedia repository, and thus have an access to the content in the repository. Step 306: When the user accesses the media content, the user express their feelings in form of individual cues or emotions. These individual cues or emotions are captured by the module present in client devices that generates the individual cues score, emotional score or emotional profile of the user associated with the content being viewed by the user. Step 308: the generated individual cues score, emotional score or emotional profile of the user is tagged to the content. The individual cues score, emotional profile or emotional scores are generated in a continuous manner, and for a particular segment of the content, the score corresponding to that segment is tagged. This results in granular individual cues or emotion based tagging of the video content. Step 310: The granular tagging of the content is done by specifically tagging the individual cues score or emotional score of the user with respect to the content being watched. Thus, the content is tagged with the individual cues score or emotional score of a large number of users. Step 312: After generating the individual cues score or emotional score of the user associated with the media content, the granular individual cues or emotional tagging of the content is shared in the central repository. Thus, the content is having a tag from a large number of users who have watched the content. Step 314: The granular individual cues score or emotional score of the content is then used to characterize the media content.

In an embodiment of the present invention, the tagged information may be used in multiple ways to increase the relevance of the content on an application specific, user specific, or delivery specific contexts.

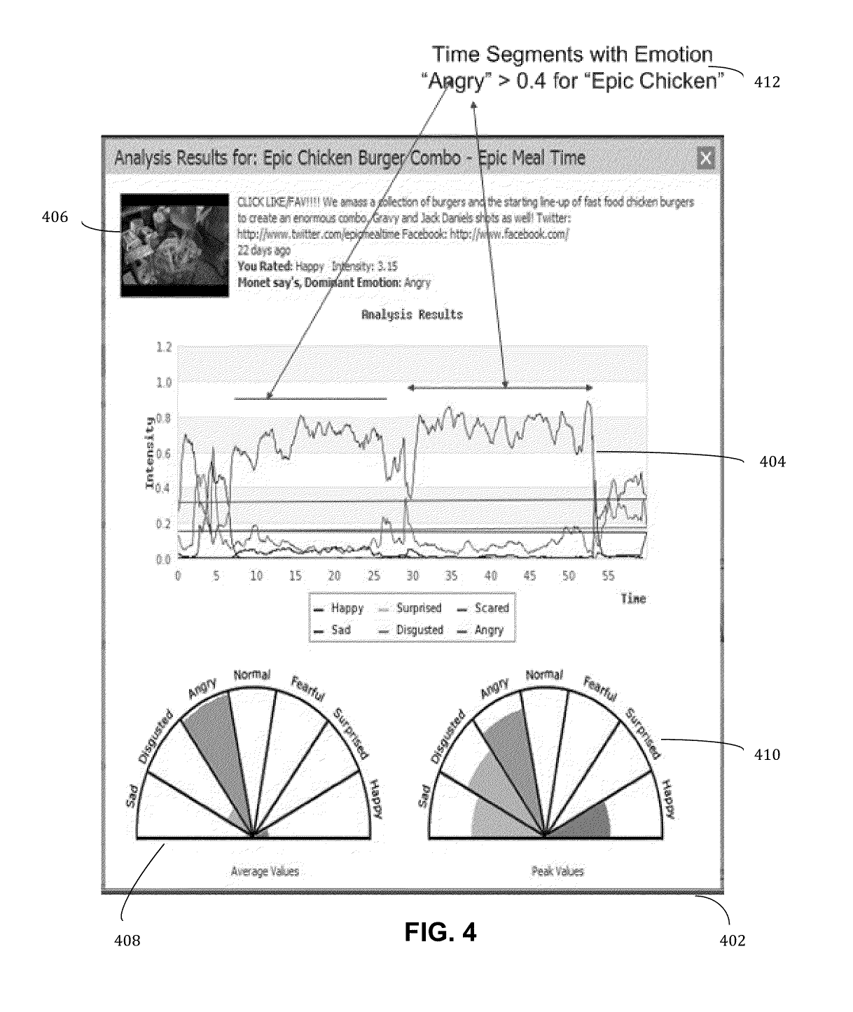

FIG. 4 illustrates a user interface showing the concept of granular individual cues or emotion based tagging of multimedia content in accordance with an embodiment of the present invention. The interface 402 shows an output of the module that detects instantaneous reaction, individual cues score, or Emotional Score in a system of the invention. The interface 402 comprises of various regions that shows the outcome of the granular individual cues or emotional tagging of the multimedia content. The region 406 provides the details of video content that has been viewed by the user and is tagged thereafter. The region 406 provides the content details along with metadata that links the content to its source, and the rating given by the user with its intensity and the rating detected by the system through its module. The interface 402 shows the output to the Emotional Score generator module for a specific content (“Epic Chicken Burger Combo” (a YouTube video)). The user's reaction on watching this video is generated by the Emotion Detection module 104. The reaction may be based on a variety of sensors (webcam, voice recording, tactile or haptic sensors, or other sensory modules). The instantaneous Emotional Score of the user is generated as a function of time as shown in region 404. The time axis is synchronized with the time stamps of the content (“Epic Chicken Burger Combo”). The instantaneous score is the normalized Emotion displayed by the user and may have a number of different emotions at any given instance. The graph in the region 404 provides the users emotional score while viewing the content in a continuous granular manner with respect to different time segments. The interface 402 further comprises of a region 408 that provides a D-graph displaying the average value of the emotional score of content 406 and a region 410 that displays a D-graph showing the peak values for the emotional score that has been generated while the user had watched the content 406.

In an embodiment of the present invention, the intensity of the detected emotions vary from the range of 0 to 1 and the different types of emotions used to predict the behavior of the user may be one of 7. The detected emotional state includes Happy, Surprised, Fearful, Normal, Angry, Disgusted, and Sad.

In another embodiment or application, the different emotions may be a smaller subset and may have scores in a different scale. This provides a method of tagging the content with an instantaneous Emotional Score based on a specific user's reaction and at a specific time stamp of the content. Thus, a uniform way of continuous and granular Emotional tagging of any content may be done. In another embodiment of the present invention, the tags may be individual cues scores instead of Emotional Scores. These individual cues scores may include attention span, gestures, head and hand movements and other sensory inputs given by the users while watching a specific content

In another embodiment of the present invention, the granular tagging of a variety of content may be done by a large number of users. The granular emotional tagging may then be used to provide a characteristic feature to large multimedia repositories that may further be used in multiple ways to characterize the content in a very granular manner.

Once, there is a uniform method of granular tagging of a content repository as described above, there are numerous applications of using the content tagged in the above fashion. Some of these applications are described below, and other related applications are readily apparent to the person skilled in the art based on the ideas described herein.

In an exemplary embodiment of the present invention, the granular emotional tagging of the multimedia content is used to identify the segment which is of concern to the users. The graph of emotional score with respect to time 404 on the reaction of content 406 being watched is used to identify the time segment of interest to the users. For instance, the different time segments of the content 306 are analyzed to find out the scene of interest, based on a query that asks to identify the segments of the video that have displayed the Emotion “Anger”>0.4. This brings out the two identified segments as shown in region 412. These kinds of queries may be generalized over a whole set of videos comprising a content repository like Netflix, or YouTube videos.

In another embodiment of the present invention, the system of the present invention is used to identify specific segments of videos that have displayed the highest time averaged specific Emotion (say, “Happy”), or specific segments from a repository that have scored (averaged over all users) a score of “Surprised>0.6”

The method of the present invention may be used to create Movie Trailers for audience based on some initial feedback from a focus group. The system may be used to pick a given set of segments with the same video of content that have scored, say “Happy>0.5”, averaged over all users, or all users in a specific age demography. The selected particular segment may be used for creating a movie trailer.

In an embodiment of the present invention, a method for analyzing a context or an event is provided. This analysis results into a system generated feedback report which include amongst others: user's emotion reactions to the context or event, user emotional profile, emotion vector etc. The user's emotions while interacting with the context or event is captured in form of user's sensory or behavioral inputs. While interacting with the context or event, the users leave their emotional traces in form of facial or verbal or other sensory cues. The client device captures various sensory and behavioral cues of the user in response to the context or event or the interaction.

The captured sensory and behavioral cues are mapped into several “Intermediate states”. In one of the embodiments of the invention these “Intermediate states” may be related to instantaneous behavioral reaction of the user while interacting with the “Event”. The intermediate states mark an emotional footprint of users covering Happy, Sad, Disgusted, Fearful, Angry, Surprised, Neutral and other known human behavioral reactions. The behavioral classification engine assigns a numerical score to each of the intermediate states that designate the intensity of a corresponding emotion. The system also optionally applies a second level of processing that combines the time-aligned sensory data captured, along with the “Intermediate states” detected for any sensors as described in the previous step, in a way to derive a consistent and robust prediction of user's “Final state” in a time continuous manner. This determination of “Final state” from the sensory data captured and the “Intermediate states” is based on a sequence of steps and mapping applied on this initial data (sensory data captured and the “Intermediate states”). This sequence of steps and mapping applied on the initial data (sensory data and the “Intermediate states”) may vary depending on the “Event” or the overall context or the use case or the application. The Final state denotes the overall impact of the digital content or event on the user and is expressed in form of final emotional state of the user. This final state may be different based on different kinds of analysis applied to the captured data depending on the “Event”, the context, or the application.

The final emotional state of the user is derived by processing intermediate states and their numerical scores. One way of arriving at the Final State may be done in the following way. For each time interval (or the captured video frame) each Intermediate State data goes through a statistical operation based on the instantaneous value of that Intermediate State and its average across the whole video capture of the user in reaction to the Event.

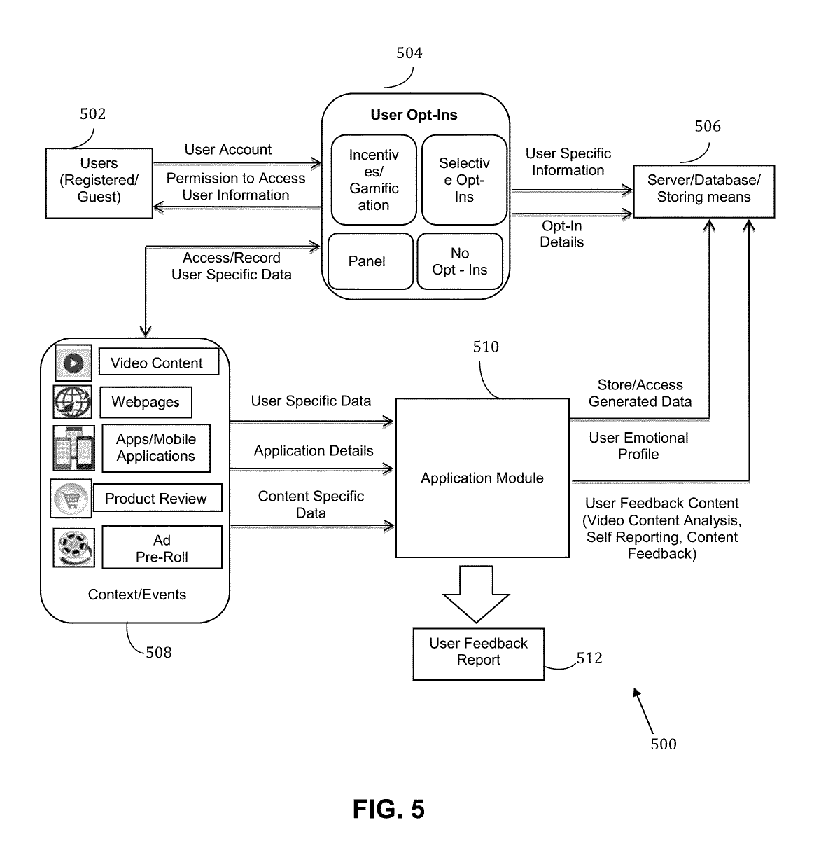

FIG. 5 illustrates a system 500 for tagging one or more context or event 508, in accordance with an embodiment of the present invention. An account is created by a user 502 by registering in the system using a client device, wherein an authorizing module 504 is configured to authorize a request coming from the user 502 to access the one or more context or event 508, where the one or more context or event 508 is a video file, a webpage, a mobile application, a product review or a product demo video. Once the user 502 registers himself, the user 502 can access the one or more context or event 508. The authorizing means 504 further comprises a user opt-in where user has the option to opt-in for incentive or gamification or other selective options or a panel or can access the one or more context or event 508 directly without selecting any opt-ins. Based on the level of opt-in the user has chosen, different levels of information will be captured and analyzed. For example, if the user chooses to be in a paid Panel, then all users video captured could be stored in the Server/Database storing means 506 in the subsequent steps and used for analysis purposes. If the user chooses Incentives and Gamification option then also user videos could be stored and analyzed. If the user choosed Selective Opt-in, the user may choose not to have his video stored, but the analytics based on user video captured could still be used. If the user chooses No-Opt in then no user video information would be used, user may still give some self reported feedback to the system. These various User Opt-in options could change and mean different things in various embodiments of the system. After registration, when the user 502 interacts with the one or more context/event 508, the user specific data, application details and content specific data is captured and stored in a storing means or a database or a server 506. The user specific data comprises captured snapshots, emotional variation of the user 502 and a self-reporting feedback with respect to the one or more context or event. The application details includes number of mouse clicks, number of clicked hyperlink or scroll tab and the content specific data comprises information on media event, session data elapsed event, time stamp and metadata.

The system 500 also comprises an application module and a processing means. The application module 510 accesses the one or more context or event 508 and analyzes the captured user specific data, application details and content specific data to generate a user feedback result 512 for a complete duration for which the user has interacted with the context or event 508. The processing means tags the user feedback result 512 with the context or event 508 in a time granular manner.

In an exemplary embodiment, said one or more context or event 508 may be a video file. The application module 510 accesses the video file, and captures the user specific data in real time while the user is viewing the video file. The captured user specific data is then analyzed to generate the user emotional profile or a feedback report. The user emotional profile is generated based on captured video, audio, and other user specific information from the user. The user is also provided with option to give their feedback. The user profile and the context information is then sent to the storing means or the database or the server. The user emotional profile and the feedback report generated by the system is also stored in the storing means. The storing means or the database or the server also include information on the session information and the user specific information. The session information includes media events, elapsed events, emotion vectors, time stamps. The user specific information includes user data, event data, timestamp data, metadata and user emotional profile data.

In another exemplary embodiment, the one or more context is a webpage. The application module allows the user to access the webpage. Thereafter, it monitors the user reactions and captures the session information. The captured user reactions and the session information is then analyzed along with the session details to generate a feedback report. The user emotional profile is generated based on captured video, audio, and other user specific information from the user. The application module then transfers the session information along with the user emotional profile and self reporting feedback together with the system generated feedback report to the storing means or server or the database. The session information includes information pertaining to an event, mouse clicks, hyperlinks on the webpage and time stamp data. The user specific information for webpage includes user emotional profile, time stamp and metadata.

In another exemplary embodiment of the present invention, the one or more context or the event is a mobile application. The application module configured for the mobile application data performs the function of accessing the mobile application and captures and records the user specific data and application specific data in real time to analyze the user specific data and the application data to generate user feedback result. The user emotional profile is generated based on captured video, audio, and other user specific information from the user. The application module transfers the context/application profile data in the form of mobile application generated data, user emotional profile, self reporting feedback report and the system generated feedback result to the server or the storing means or the database. The context/application profile data includes the user information, event, application information and timestamp data. The user specific information includes user emotional profile, emotional vector, timestamp and metadata.

In another exemplary embodiment of the present invention, the one or more content is a product review or a product demo video. The application module first accesses the product review or the product demo content. The application module monitors or captures the review session, the user reactions captured with video and/or audio, and analyzes the review session data to generate the system feedback report. The user emotional profile is generated based on captured video, audio, and other user specific information from the user. The application module then transfers the product information, user specific information, self reported feedback report and system generated feedback result to the storing means or the database or the server. The product information includes product review profile such as user information, event data, review data and timestamp data. The user specific information includes user emotional profile, emotion, time stamp and metadata.

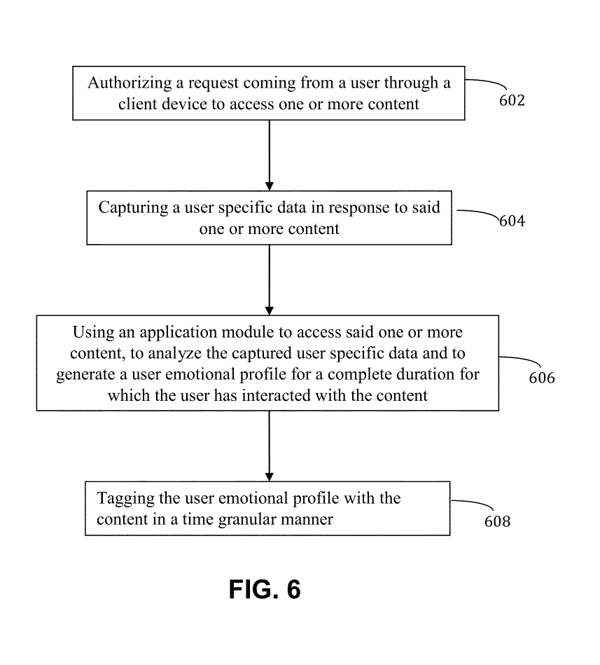

FIG. 6 shows a block diagram illustrating the method for tagging context or event, in accordance with an embodiment of the present invention. The method of tagging includes the steps of authorization, data capturing, analysis of the captured data and profile generation. A user registers himself or herself to interact with one or more online content, wherein the one or more online content is a video file, a webpage, a mobile application and a product review or a product demo video. At step 602, a request coming from the user through a client device to access one or more online content is being authorized at the backend. After authorization, user can access the one or more online content. When the user interacts with the one or more online content, his/her user specific data (that would include user's video and audio reaction and any other captured inputs through other sensory inputs like gestures, haptic or tactile feedback), application details and content specific data is captured accordingly at step 604. In the present invention, the user specific data is the data selected from captured snapshots, audio and video inputs, emotional variation of the user and a self-reporting feedback, the application details are number of mouse clicks, number of clicked hyperlink or scroll tab and the content specific data is information on media event, session data elapsed event, time stamp and other media event related metadata such as rewind, fast forward, pause etc. In the step 606, an application module accesses the one or more online content, to further analyze the captured user specific data, the application details and the content specific data and thereby generates a user emotional profile for a complete duration for which the user has interacted with the content. The user emotional profile is generated based on captured video, audio, and other user specific information from the user. After generation of the user emotional profile, tagging of the user emotional profile is done with the one or more online content in a time granular manner at the step 608.

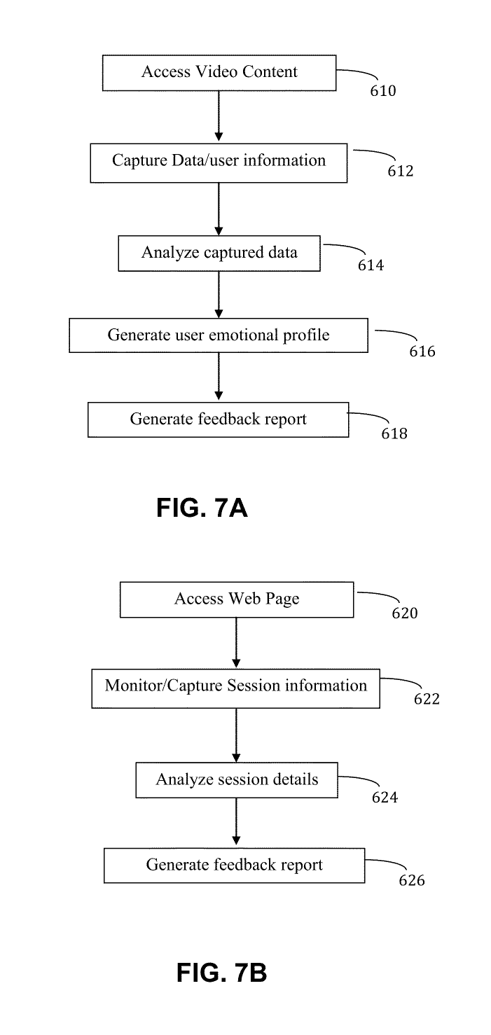

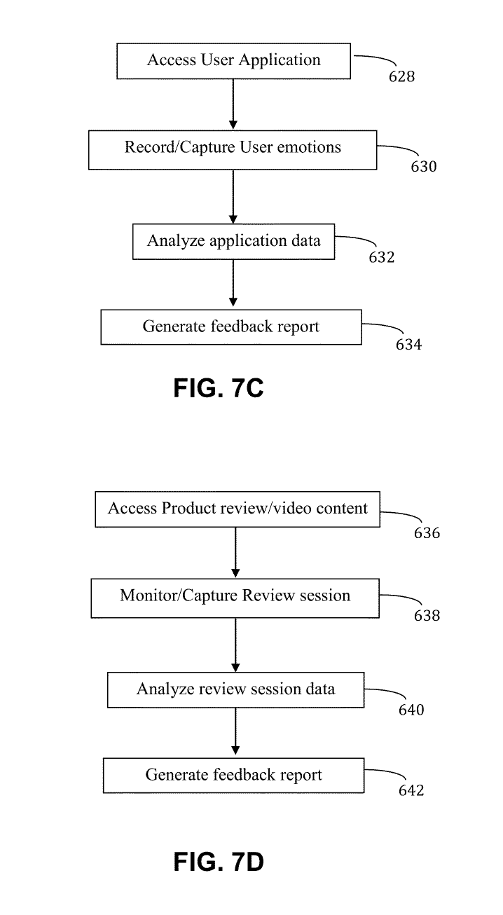

FIG. 7A shows a block diagram illustrating the method used by an application module for tagging a video file, in accordance with an exemplary embodiment of the present invention. The application module generates a feedback report for the video file. The feedback report is generated by a method comprising: At step 610, the application module accesses the video content. Proceeding at step 612, capturing the user specific data in real time followed by step 614: analyzing the user specific data. At step 616, user emotional profile is generated and at step 618: the feedback report is generated for the video file.

FIG. 7B shows a block diagram illustrating the method used by an application module for tagging a web page, in accordance with an exemplary embodiment of the present invention. The application module generates a feedback report for the webpage by following a method, the method comprising: At step 620 accessing the webpage, followed by step 622 of capturing the user specific data and content specific data in real time and then at step 624 analyzing the user specific data and the content specific data. At step 626, the application module generated the feedback report for the webpage.

FIG. 7C shows a block diagram illustrating the method used by an application module for tagging a mobile application, in accordance with an exemplary embodiment of the present invention. A feedback report is generated by the application module by following: At step 628, the user first accesses the mobile application using the application module. During the interaction his/her user specific data and application details are captured in real time at step 630. After this, the user specific data and the application details are analyzed at step 632 to generate the user emotional profile at step 634.

FIG. 7D shows a block diagram illustrating the method used by an application module for tagging a product review or a product demo video, in accordance with an exemplary embodiment of the present invention. The application module generates a feedback report for the product review or demo video by following the method comprising: At step 636 the application module accesses the product review, and captures the user specific data and the content specific data in real time at step 638. The application module, analyzes the user specific data and the content specific data in step 640 and the application module generates the feedback report at step 642.

The foregoing merely illustrates the principles of the present invention. Other variations to the disclosed embodiments can be understood and effected by those skilled in the art in practicing the claimed invention from a study of the drawings, the disclosure, and the appended claims. In the claims, the word “comprising” does not exclude other elements or steps and the indefinite article “a” or “an” does not exclude a plurality. The mere fact that certain measures are recited in mutually different dependent claims does not indicate that a combination of these measures cannot be used advantageously. Any reference signs in the claims should not be construed as limiting the scope of the claims. Various modifications and alterations to the described embodiments will be apparent to those skilled in the art in view of the teachings herein. It will thus be appreciated that those skilled in the art will be able to devise numerous techniques which, although not explicitly described herein, embody the principles of the present invention and are thus within the spirit and scope of the present invention. All references cited herein are incorporated by reference in their entireties.

We claim:

1. A system for tagging a content, the system comprising:
an authorizing module configured to authorize a request coming from a user through a client device to access one or more content;
a capturing means to capture a user specific data in response to said one or more content;
an application module for accessing said one or more content, analyzing the captured user specific data and to generate a user emotional profile for a complete duration for which the user has interacted with the content;
a processing means to tag the user emotional profile with the content in a time granular manner.

2. The system of claim 1, wherein the user emotional profile is generated based on the user specific data, content specific data and application details.

3. The system of claim 1, wherein the authorizing means further comprises a user opt-in providing one or more options for the user to access the system.

4. The system of claim 1, further comprising a storing means to store said one or more content tagged with the user emotional profile.

5. The system of claim 4, wherein the storing means store a self reported user feedback, user emotional profile and user snapshot at timed interval along with the said one or more content tagged with the user emotional profile.

6. The system of claim 1, wherein the user specific data comprises one or more of the data selected from captured snapshots, emotional variation of the user and a self reporting feedback.

7. The system of claim 1, wherein the application details comprises number of mouse clicks, number of clicked hyperlink or scroll tab.

8. The system of claim 1, wherein the content specific data comprises information on media event, session data elapsed event, time stamp and metadata.

9. The system of claim 1, wherein the content is a video file.

10. The system of claim 7, wherein the application module provide access to the video file; capture the user specific data in real time; analyze the user specific data to generate the user emotional profile.

11. The system of claim 1, wherein the content is a webpage.

12. The system of claim 11, wherein the application module: accesses the webpage, captures the user specific data in real time and the content specific data and analyzes the user specific data and the content specific data to generate the user emotional profile.

13. The system of claim 1 wherein the content is a mobile application.

14. The system of claim 13, wherein the application module: accesses the mobile application, captures the user specific data in real time and the application data and analyzes the user specific data and the application data to generate the user emotional profile.

15. The system of claim 1 wherein the content is a product review or a product demo video.

16. The system of claim 13, wherein the application module: accesses the product review, captures the user specific data in real time and the content specific data and analyzes the user specific data and the content specific data to generate the user emotional profile.

17. A method for tagging a content, the method comprising:
authorizing a request coming from a user through a client device to access one or more content;
capturing a user specific data in response to said one or more content;
using an application module to access said one or more content, to analyze the captured user specific data and to generate a user emotional profile for a complete duration for which the user has interacted with the content;
tagging the user emotional profile with the content in a time granular manner.

18. The method of claim 17, wherein the user emotional profile is generated based on the user specific data, content specific data and application details.

19. The method of claim 17, further comprising: storing said one or more content tagged with the user emotional profile in a storing means.

20. The method of claim 19, wherein the storing means store a self reported user feedback, user emotional profile and user snapshot at timed interval along with the said one or more content tagged with the user emotional profile.

21. The method of claim 17, wherein the user specific data comprises one or more of the data selected from captured snapshots, emotional variation of the user and a self reporting feedback.

22. The method of claim 17, wherein the application details comprises number of mouse clicks, number of clicked hyperlink or scroll tab.

23. The method of claim 17, wherein the content specific data comprises information on media event, session data elapsed event, time stamp and metadata.

24. The method of claim 17, wherein the content is a video file.

25. The method of claim 24, wherein the application module provides access to the video file; captures the user specific data in real time and analyzes the user specific data to generate the user emotional profile.

26. The method of claim 17, wherein the content is a webpage.

27. The method of claim 26, wherein the application module: accesses the webpage, captures the user specific data in real time and the content specific data and analyzes the user specific data and the content specific data to generate the user emotional profile.

28. The method of claim 17, wherein the content is a mobile application.

29. The method of claim 28, wherein the application module: accesses the mobile application, captures the user specific data in real time and the application data and analyzes the user specific data and the application data to generate the user emotional profile.

30. The method of claim 17, wherein the content is a product review or a product demo video.

31. The method of claim 30, wherein the application module: accesses the product review, captures the user specific data in real time and the content specific data and analyzes the user specific data and the content specific data to generate the user emotional profile.
